(19) United States
(12) Patent Application Publication
(10) Pub. No.: US 2026/0071687 A1
(43) Pub. Date: Mar. 12, 2026

(54) VALVE BLOCK, COOLANT CIRCUIT AND METHOD FOR OPERATION AND PRODUCTION

(71) Applicant: ETO MAGNETIC GMBH, Stockach (DE)

(72) Inventors: Joerg AURICH, Burkhardtsdorf (DE); Frank HOHMANN, Vetschau (DE); Andreas RINDT, Berlin (DE); Leonhard TRAPP, Berlin (DE)

(21) Appl. No.: 19/107,712

(22) PCT Filed: Aug. 18, 2023
(86) PCT No.: PCT/EP2023/072846

§ 371 Date: Feb. 28, 2025

(30) Foreign Application Priority Data
Sep. 1, 2022 (DE) 10 2022 122 207.1

(51) Int. Cl. F16K 11/16; F16K 31/524; F25B 41/31

(52) U.S. Cl. CPC F16K 11/166; F16K 31/52416; F25B 41/31

(57) ABSTRACT

A valve block for a refrigerant circuit comprises at least one refrigerant valve unit having at least one first refrigerant valve and at least one second refrigerant valve which are each configured at least to influence a refrigerant flow of the refrigerant circuit and comprises a valve control unit which is configured at least to control and/or to pilot at least some of the refrigerant valves of the refrigerant valve unit, wherein the valve control unit has a specifically actuatable camshaft for actuating a plurality of refrigerant valves and/or a plurality of pilot valves of the valve control unit, in particular for actuating at least one first pilot valve of the valve control unit to pilot the first refrigerant valve and for actuating at least one second pilot valve of the valve control unit to pilot the second refrigerant valve.

### CROSS-REFERENCE TO RELATED APPLICATIONS

This patent application is a U.S. national stage application of international patent application PCT/EP2023/072846, filed Aug. 18, 2023, which is based on and claim priority to German patent application DE 10 2022 122 207.1, filed Sep. 1, 2022, the contents which are incorporated herein by reference.

### PRIOR ART

The invention relates to a valve block, to a refrigerant circuit, and to methods.

It has already been proposed for valves, in particular shut-off valves in refrigerant circuits, to be arranged separately from one another and in a distributed manner and to be actuated separately from one another, for example by means of individual electromagnets. To that end, a large number of actuators, connecting pipes, connecting hoses and seals are required.

The object of the invention is, in particular, to provide a device of the type in question having advantageous properties in terms of efficiency, in particular production efficiency. The object is achieved according to the invention.

### ADVANTAGES OF THE INVENTION

A valve block at least for a refrigerant circuit, in particular in a vehicle, preferably in a battery-electrically vehicle (BEV), and/or in a heat pump, preferably a building heat pump, is proposed, comprising at least one refrigerant valve unit having at least one first refrigerant valve and at least one second refrigerant valve which are each configured at least to influence a refrigerant flow of the refrigerant circuit, and comprising a valve control unit, in particular a mechanical valve control unit, which is configured at least to control and/or pilot at least some of the refrigerant valves of the refrigerant valve unit, wherein the valve control unit has a specifically actuatable camshaft for actuating a plurality of refrigerant valves and/or a plurality of pilot valves of the valve control unit, in particular for actuating at least one first pilot valve of the valve control unit to pilot the first refrigerant valve and for actuating at least one second pilot valve of the valve control unit to pilot the second refrigerant valve. As a result, efficiency, in particular cost efficiency, can advantageously be increased by more cost-effective production and/or by a reduction in components. Advantageously, a number of electromagnets in a refrigerant circuit can be substantially reduced. In addition, efficiency of use of the available space can advantageously be increased. In addition, in particular as a result of joint actuation or piloting of a plurality of valves, power consumption, in particular of a refrigerant circuit, can be reduced, and this can help to increase the range in particular in BEVs. In addition, a leakage risk and/or a fault risk of refrigerant circuits can advantageously be reduced, in particular in that a number of connecting points within the refrigerant circuit can advantageously be reduced.

In particular, the valve block comprises a plurality of integrated valves and/or fluid lines, in particular refrigerant lines. In particular, a refrigerant circuit is configured for cooling, in particular by means of cooling air, a space, for example a driver's cab of a vehicle, in particular of a BEV. In particular, the refrigerant circuit forms at least a part of a cooling unit, in particular of an air-conditioning system, preferably of a vehicle air-conditioning system, or of a heat pump, in particular of a house heat pump or of a vehicle heat pump. Preferably, the refrigerant circuit is constructed in a manner known to a person skilled in the art and comprises in particular at least an evaporator, a condenser, a compressor and/or a throttle device (expansion valve). A more comprehensive explanation of the operation of a cooling unit and/or of a refrigerant circuit will not be provided at this point, since a person skilled in the art is familiar with this. The vehicle may be in the form of a land vehicle, such as a passenger car, a truck, a construction machine or a train, of a watercraft, such as a ship, a hovercraft or an amphibious vehicle, or of an aircraft, such as an airplane, a helicopter or an airship. The refrigerant circuit may be configured to control the temperature of a vehicle driver's cab, for example a driver's compartment of a locomotive, of a bus or of a construction vehicle, or to control the temperature of a passenger compartment, for example of a passenger railroad car. Preferably, the vehicle is in the form of a fully battery-operated vehicle or of a hybrid vehicle. Alternatively, the refrigerant circuit may be configured for use in building heat pumps, in particular house heat pumps. Further additional applications in refrigerant circuits used elsewhere are also conceivable.

A refrigerant should be understood in particular as being a fluid which transports enthalpy from a space to be cooled to an environment outside the space to be cooled. The difference from a coolant is in particular that the refrigerant in the refrigerant circuit can do this against a temperature gradient such that, with consumption of supplied energy, the ambient temperature may even be higher than the temperature of the space to be cooled. By contrast, a coolant is only capable of transporting the enthalpy in a cooling circuit along the temperature gradient to a point at a lower temperature. Examples of refrigerants are ammonia, carbon dioxide, hydrocarbons such as isobutane, propane or pentane, or halogen hydrocarbons.

The refrigerant valves of the refrigerant valve unit are integrated in particular into a common component, in particular the valve block or a refrigerant valve module of the valve block. In particular, the refrigerant valves are configured to throttle, to shut off and/or to enable the refrigerant flow. “Configured” is in particular to mean specifically programmed, designed and/or equipped. The fact that an object is configured for a particular function should be understood in particular as meaning that the object fulfills and/or executes this particular function in at least one application state and/or operation state. The camshaft and/or the pilot valves of the valve control units are integrated in particular in a common component, in particular the valve block or a valve control module of the valve block. The pilot valves are preferably different than solenoid valves. The pilot valves are preferably free from separate actuation (independent of the camshaft). In particular, the valve control unit forms a refrigerant valve pilot unit which is configured preferably to pilot the valve control unit purely mechanically. The valve block may also be free of piloting. In this case, the camshaft actuates the refrigerant valves directly, while, with integration of piloting, the camshaft directly actuates the pilot valves, which in turn then actuate the refrigerant valves. The refrigerant valve unit and the valve control unit may be integrated jointly in a single valve block or be in two separate valve block modules (valve control module and refrigerant valve module), which form the valve block after being joined together. As a result, modularity of the valve block assembly could be achieved. The fact that the camshaft is “specifically actuatable” should be understood in particular as meaning that a rotational position of the camshaft is settable specifically and/or selectively.

In particular, the valve block has an open-loop and/or closed-loop control unit. The open-loop and/or closed-loop control unit is configured at least to specifically actuate the camshaft, in particular an electric motor unit driving the camshaft. An “open-loop and/or closed-loop control unit” should be understood in particular as being a unit with at least one control electronic system. A “control electronic system” is in particular to mean a unit having a processor and having a memory element and having an operating program stored in the memory element. The refrigerant valve unit forms in particular at least a part of the refrigerant circuit, preferably a part of the refrigerant circuit through which a refrigerant of the refrigerant circuit flows. The refrigerant circuit is preferably formed differently than a coolant circuit. The refrigerant circuit is preferably formed differently than a purely hydraulic circuit. The refrigerant circuit is preferably formed differently than a purely pneumatic circuit. The refrigerant circuit is preferably configured to guide a fluid in two different states of matter (gaseous and liquid).

It is also proposed that the valve control unit has at least the electric motor unit, in particular comprising at least one stepping motor or having at least one electrically commutated DC motor, for driving the camshaft in an angle-controlled manner. As a result, it is advantageously possible for a large number of switching patterns of the valve block to be specifically actuated. In addition, a universal structure may advantageously be allowed. For an altered valve logic of the valve block, it would then only be necessary, for example, to exchange the camshaft. In particular, the camshaft comprises a plurality of cam rings, which each have cams for actuating the refrigerant valves and/or the pilot valves. “Driving the camshaft in an angle-controlled manner” should be understood in particular as meaning that at least substantially exact angular positions of the camshaft are settable by means of the electric motor unit. In this connection, “substantially exact” should be understood in particular as meaning an exactness of the angular setting of the camshaft of at least ±5°, preferably at least ±2.5° and preferentially at least ±1°. The electric motor unit may have a reduction gear. As a result, exactness of actuation can advantageously be increased. In particular, the electric motor unit forms a central actuating unit for at least a majority of the refrigerant valves and/or for the pilot valves.

Furthermore, it is proposed that the camshaft is designed to actuate more than two, preferably more than three and preferentially more than four refrigerant valves of the refrigerant valve unit or pilot valves of the valve control unit. As a result, efficiency, in particular cost efficiency, can advantageously be increased by more cost-effective production and/or by a reduction in components.

If all of the refrigerant valves of a functional refrigerant circuit are integrated in the valve block, efficiency, in particular cost efficiency, can be increased by more cost-effective production and/or by a reduction in components and/or efficiency of available space can be increased by reducing the available space. A refrigerant valve may be formed by a shut-off valve and/or by an expansion valve. In particular, all the shut-off valves of the functional refrigerant circuit are integrated in the valve block. In particular, all the expansion valves of the functional refrigerant circuit are integrated in the valve block. In particular at least two refrigerant valves with fundamentally different tasks and functions are integrated in the valve block. In particular, at least one shut-off valve and at least one expansion valve are integrated in the valve block.

Moreover, it is proposed that the pilot valves of the valve control unit or the refrigerant valves of the refrigerant valve unit are arranged in a row parallel to an axis of rotation of the camshaft and/or around the axis of rotation of the camshaft in the circumferential direction of the camshaft. As a result, high efficiency, in particular efficiency of available space can advantageously be achieved. Advantageously, all the corresponding valves can be actuated/piloted jointly by a single camshaft or by a single specifically actuated electric motor unit.

If the first refrigerant valve and/or the second refrigerant valve are/is realized as a shut-off valve for, in particular completely, blocking the refrigerant flow at least in a subregion of the refrigerant circuit, in particular at least one refrigerant line of a line system, comprising a plurality of refrigerant lines, of the refrigerant circuit, efficient actuation and/or piloting of the shut-off valves of the refrigerant circuit can advantageously be achieved. The shut-off valves are in particular all different than solenoid valves. The shut-off valves are in particular free from separate actuation (apart from a possibly respectively associated pilot valve). In particular, the valve block comprises more than two, preferably more than three and preferentially more than four shut-off valves. A shut-off valve is in particular in the form of a fitting for controlled opening and/or closing of flow-through openings in the line system of the refrigerant circuit or of refrigerant lines of the line system of the refrigerant circuit.

If, alternatively or additionally, the first refrigerant valve, the second refrigerant valve and/or at least one separately actuated third refrigerant valve, in particular separately actuated independently from the camshaft, of the refrigerant valve unit are/is realized as an expansion valve of the refrigerant circuit, particularly complete integration of the valves required for implementing a refrigerant circuit into a single valve block can advantageously be achieved. Advantageously, cost efficiency, component efficiency and/or efficiency of available space can be improved. The expansion valve forms in particular a device which, as a result of a local constriction of a flow cross section of a refrigerant line of the line system of the refrigerant circuit, reduces a pressure of the refrigerant flowing through and thus brings about an increase in volume or expansion of the refrigerant. The expansion valve may be in the form of a controlled expansion valve. Frequently, the refrigerant in cooling circuits enters the expansion valve as a virtually boiling liquid and then experiences, in the expansion valve, a change in state that, to a first approximation, is adiabatically isenthalpic, wherein in particular one part of the refrigerant evaporates on passing through the expansion valve, while another part of the refrigerant remains in the liquid state. The expansion valve(s), integrated in particular in the valve block, may be actuated separately (independently of the camshaft). Alternatively, however, it is also conceivable for the expansion valve(s) to (also) be actuated by the camshaft or by a further camshaft.

If, in this case, the camshaft has at least one cam ring comprising a cam that forms a flat ramp, fine actuation of the expansion valve via the camshaft can advantageously by allowed. In particular, the flat ramp initially rises steadily and flatly in the circumferential direction of the cam. After a maximum, the flat ramp can drop steadily and flatly again in the circumferential direction of the camp. In particular, in this case, the electric motor unit is also particularly precisely and finely actuatable in order to allow fine tuning of the setting of the expansion valve via the camshaft.

Furthermore, it is proposed that the camshaft has a plurality of cam rings, which are each configured at least to actuate at least one refrigerant valve or at least one pilot valve, wherein the arrangement of the cam rings on the camshaft forms a plurality of specific switching patterns for switching different operation states of the refrigerant circuit. As a result, a high level of flexibility can advantageously be achieved. Advantageously, easy and reliable setting even of complicated switching patterns can be allowed. In addition, a universal structure can advantageously be allowed, wherein, to change a valve logic, it is advantageously necessary only to exchange the camshaft. A cam ring should be understood in particular as being a part of the camshaft which, as seen in the axial direction, is formed at least substantially uniformly at least in the circumference of the camshaft. In particular, each cam ring comprises at least one cam which is configured to actuate at least one refrigerant valve or at least one pilot valve. In particular, the cam, as seen from the axis of rotation, forms an elevation in the radial direction. In particular, the camshaft forms, depending on rotational position, at least two, preferably more than two, preferentially more than three and particularly preferably more than four, different specific switching patterns for switching different operation states of the refrigerant circuit. Each switching pattern corresponds in this case to a different switching combination of all the refrigerant valves and/or pilot valves controlled by the camshaft.

If the camshaft has a number of cam rings that is is less than a number of pilot valves of the valve control unit which are actuated by the camshaft, and/or than a number of refrigerant valves of the refrigerant valve unit which are actuated by the camshaft, a particularly compact structure can advantageously be allowed. Advantageously, the camshaft can have a particularly short design. In particular, the number of cam rings may, in this case, be smaller than the total number of valves (pilot valves and refrigerant valves) that are actuated by the camshaft.

If, alternatively or additionally, the camshaft has a cam ring which is configured to actuate two or more different pilot valves or two or more different refrigerant valves, a particularly compact structure can advantageously be allowed. Advantageously, the camshaft can have a particularly short design. It is conceivable here for a cam/elevation of the cam ring to extend over a greater part of the circumferential direction of the camshaft in order, depending on the position of the camshaft, to interact with no valve, with one valve or with more than one valve. It is likewise conceivable here for the cam ring to have two or more separate cams/elevations along its circumferential direction, which, depending on the position of the camshaft, each interact or do not interact with a valve. It is also possible for a plurality of cams/elevations of a cam ring to have different widths (as seen in the circumferential direction).

Furthermore, it is proposed that each pilot valve of the valve control unit is connected, in particular fluidically, to the respective associated refrigerant valve at least via a control channel. As a result, easy and/or efficient (electronics-free) piloting of the refrigerant valves can be achieved. Advantageously, as a result of the refrigerant valves being piloted by means of the pilot valve, high energy efficiency can be achieved. In addition, it is possible, as a result, for the force required for actuating the refrigerant valves to be able to be kept low. As a result, compact and/or energy-saving electric motor units driving the camshaft can advantageously be used. The control channel may be embodied as a control bore or have any other desired shape, any other desired course or any other desired cross section than a bore.

If, in addition, each pilot valve of the valve control unit is connected, in particular fluidically, to the same respective associated refrigerant valve at least via a further control channel, easy and/or efficient (electronics-free) piloting of the refrigerant valves can advantageously be achieved. In particular, the pilot valves are connected to the refrigerant circuit (indirectly) via the control channels. In particular, the internal pressures in the refrigerant circuit are used to transmit the piloting movement received by the camshaft from the pilot valve to the associated refrigerant valve. In particular, via the control channel, the internal pressure in the refrigerant circuit is transmitted to the pilot valve while, via the further control channel, the pressure of the pilot valve (i.e., with the pilot valve open, the internal pressure, transmitted via the control channel to the pilot valve, in the refrigerant circuit) is transmitted onward to the refrigerant valve, in particular to one of the tappet sides of the refrigerant valve.

Furthermore, it is proposed that each pilot valve has at least one transmission element which is configured to transmit a camshaft signal mechanically to a valve element of the respective pilot valve. As a result, easy and/or efficient (electronics-free) piloting can advantageously be allowed. In particular, the transmission element is in the form of a pin, for example a cylindrical pin, or of a tappet. In particular, the transmission element is in touching contact with the camshaft. In particular, the transmission element is configured to be displaced in the longitudinal direction by a cam of the camshaft. The transmission element can be fixedly connected to the valve element or be separate from the valve element. The valve element is formed, in particular, by a valve slide. The valve element is configured, in particular, seal off a valve seat in such a way that it can be opened. For example, the valve element may be in the form of a sealing ball which is configured to sit on a valve seat forming a round opening. Upon direct actuation of the refrigerant valves by the camshaft without the use of pilot valves, the transmission element and/or the valve element can be assigned to one of the refrigerant valves.

Furthermore, it is proposed that the pilot valves are realized as normally-closed valves. As a result, high energy efficiency can advantageously be achieved. In particular, the pilot valve comprises a restoring unit which is configured to automatically reset the valve element into the closed state (i.e. the state sitting on the valve seat. The restoring unit can be formed, for example, by a spiral compression spring.

In addition, it is proposed that the valve block has at least one integrated pressure/temperature sensor. As a result, efficiency, in particular cost efficiency and/or efficiency of use of available space, can advantageously be increased. In particular, the pressure/temperature sensor can be configured to supply data which allow precise actuation of the expansion valves. In particular, the pressure/temperature sensor can be configured to supply data which allow suitable actuation of the camshaft, in particular of the individual switching patterns of the camshaft. In particular, the pressure/temperature sensor is configured to determine a pressure and/or a temperature of the refrigerant at at least one or at a plurality of points in the refrigerant circuit.

Furthermore, a refrigerant circuit, in particular in a vehicle, preferably in a battery-electrically driven vehicle, and/or in a heat pump, preferably a building heat pump, having the valve block is proposed. As a result, efficiency, in particular cost efficiency can be advantageously be increased by more cost-effective production and/or by a reduction in components. Advantageously, a number of electromagnets in a refrigerant circuit can be substantially reduced. In addition, efficiency of the use of available space can advantageously be increased.

Furthermore, a method for operating the refrigerant circuit is proposed, wherein, in at least one operating step, the specifically actuatable camshaft is used to actuate a plurality of refrigerant valves which are integrated in the common valve block and/or a plurality of pilot valves which are integrated in the common valve block in order to pilot the refrigerant valves which are integrated in the common valve block. As a result, efficiency, in particular cost efficiency, can advantageously be increased by more cost-effective production and/or by a reduction in components. Advantageously, a number of electromagnets in a refrigerant circuit can be substantially reduced. In addition, efficiency of the use of available space can advantageously be increased.

Moreover, a method for producing the valve block is proposed, wherein, in at least one production step, a plurality of refrigerant valves and preferably a plurality of pilot valves for piloting the refrigerant valves are integrated into a common valve block. As a result, efficiency, in particular cost efficiency can advantageously be increased by more cost-effective production and/or a reduction in components. Advantageously, a number of electromagnets in a refrigerant circuit can be substantially reduced. In addition, efficiency of the use of available space can advantageously be increased. Each of the refrigerant valves and/or pilot valves integrated into the common valve block have no separate control.

The valve block according to the invention, the refrigerant circuit according to the invention and the methods according to the invention are not configured to be restricted to the above-described application and embodiment. In particular, in order to fulfill an operating principle described herein, the valve block according to the invention, the refrigerant circuit according to the invention and the methods according to the invention may have a number of individual elements, method steps, components and units that differs from a number mentioned herein.

### DRAWINGS

Further advantages will become apparent from the following description of the drawings. The drawings illustrate two exemplary embodiments of the invention. The drawings, the description and the claims contain numerous features in combination. A person skilled in the art will expediently also consider the features individually and combine them into meaningful further combinations.

In the drawings:

FIG. 1a shows a schematic illustration of a vehicle having an air-conditioning system which has a refrigerant circuit with a valve block according to the invention,

FIG. 1b shows a schematic illustration of a building having a heat pump which has the refrigerant circuit with the valve block according to the invention,

FIG. 2a shows a schematic illustration of the valve block in a first exterior view,

FIG. 2b shows a schematic illustration of the valve block in a second exterior view,

FIG. 3a shows a schematic top view of the valve block,

FIG. 3b shows a section through the valve block along a section axis A indicated in FIG. 3a,

FIG. 4a shows a schematic top view of the valve block,

FIG. 4b shows a section through the valve block along a section axis B indicated in FIG. 4a, with an integrated refrigerant valve in a closed state,

FIG. 4c shows a section through the valve block along a section axis B indicated in FIG. 4a, with the integrated refrigerant valve in an open state,

FIG. 5a shows a schematic illustration of a camshaft of the valve block,

FIG. 5b shows a schematic switching pattern diagram of the camshaft of the valve block,

FIG. 6 shows a schematic flow chart of a method for operating the refrigerant circuit,

FIG. 7 shows a schematic flow chart of a method for producing the valve block,

FIG. 8a shows a schematic illustration of an alternative camshaft of an alternative valve block in a first view,

FIG. 8b shows a schematic illustration of an alternative camshaft of an alternative valve block in a second view,

FIG. 8c shows a schematic illustration of a further alternative camshaft of the alternative valve block in the first view, and

FIG. 9 shows a further implementation, not according to the invention, of shut-off valves.

### DESCRIPTION OF THE EXEMPLARY EMBODIMENTS

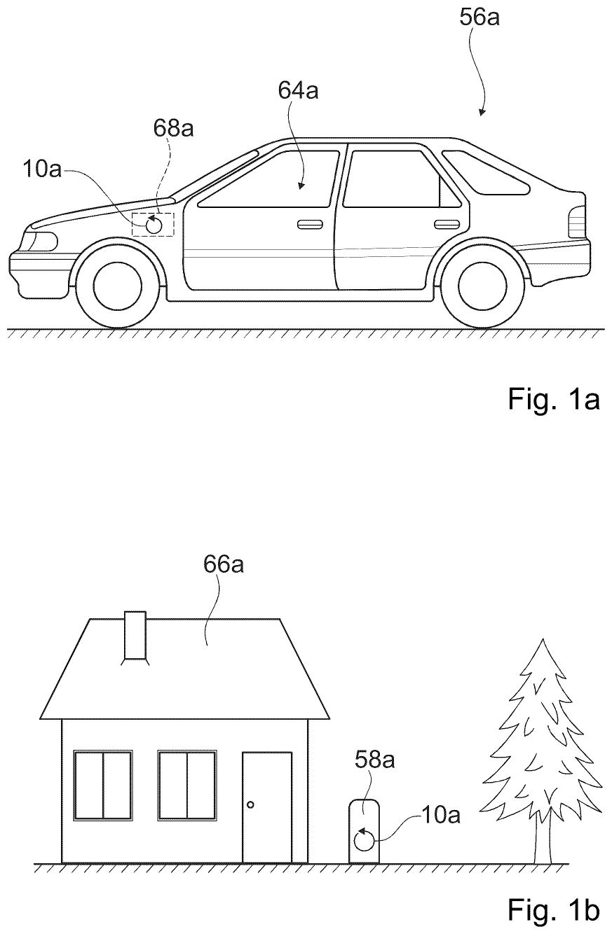

FIGS. 1a and 1b schematically show a vehicle 56a comprising an air-conditioning system 68a, having a refrigerant circuit 10a according to the invention, for cooling a passenger compartment 64a of the vehicle 56a, and, respectively, a building 66a comprising a heat pump 58a, having the refrigerant circuit 10a according to the invention, for cooling the rooms of the building 66a. The refrigerant circuit 10a is configured to transport a refrigerant. The refrigerant circuit 10a is configured to transport thermal energy against a temperature gradient.

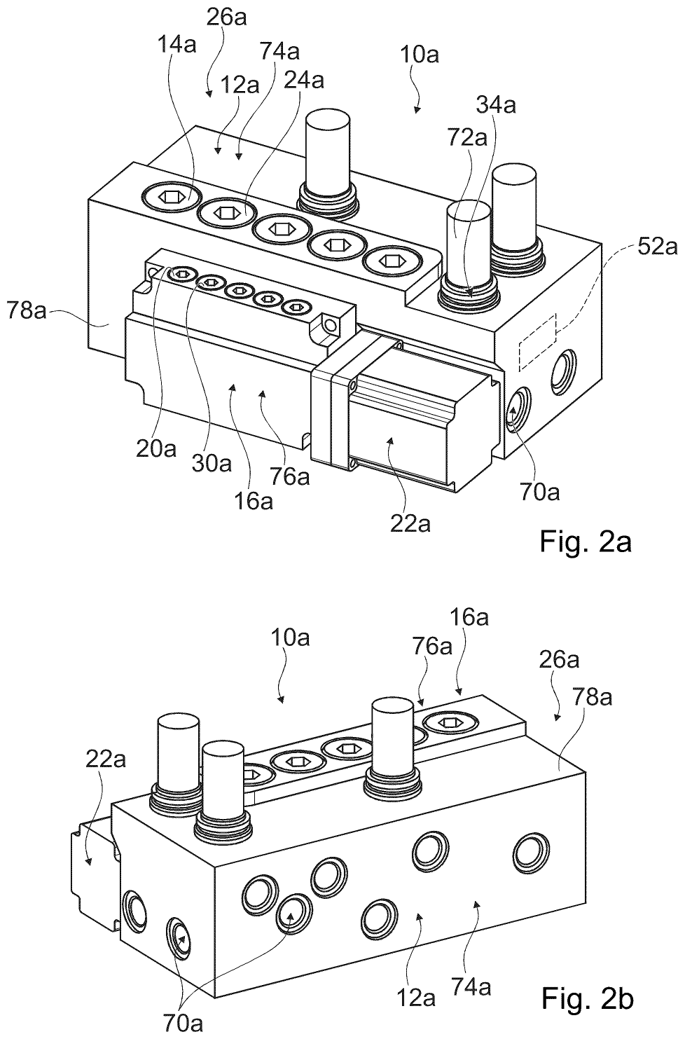

The refrigerant circuit 10a comprises a valve block 26a. The valve block 26a is illustrated schematically in an exterior view in FIGS. 2a and 2b. The valve block 26a comprises a plurality of ports 70a for connecting to a line system (not illustrated) of the refrigerant circuit 10a. The valve block 26a has an integrated pressure/temperature sensor 52a. The valve block 26a may optionally have further integrated pressure/temperature sensors in addition to the pressure/temperature sensor 52a.

The valve block 26a has a refrigerant valve unit 12a. The refrigerant valve unit 12a comprises a first refrigerant valve 14a. The first refrigerant valve 14a is configured to influence the refrigerant flow of the refrigerant circuit 10a. The first refrigerant valve 14a is in the form of a shut-off valve. Shut-off valves are designed to block a refrigerant flow in a subregion of the refrigerant circuit 10a. The refrigerant valve unit 12a comprises a second refrigerant valve 24a. The second refrigerant valve 24a is in the form of a shut-off valve. The refrigerant valve unit 12a comprises a third refrigerant valve 34a. The third refrigerant valve 34a is in the form of an expansion valve. The expansion valve is configured to throttle a flow cross section of the refrigerant flow in a subregion of the refrigerant circuit 10a. The third refrigerant valve 34a is separately actuatable. The third refrigerant valve 34a comprises an electromagnet 72a for actuating a throttling state of the expansion valve. The valve block 26a illustrated by way of example in FIG. 2 has further shut-off valves and further expansion valves, which have not been provided with a reference sign. As a whole, the shown valve block 26a has eight refrigerant valves 14a, 24a, which are formed by five shut-off valves and three expansion valves. The refrigerant valves 14a, 24a are all integrated in the valve block 26a. The valve block 26a comprises a refrigerant valve module 74a. All the refrigerant valves 14a, 24a, 34a of the valve block 26a are arranged in the refrigerant valve module 74a.

The valve block 26a comprises a valve control unit 16a. The valve control unit 16a is in the form, for example, of a valve pilot unit. Alternatively, the valve block could also be entirely without a piloting function, in which case the refrigerant valves 14a, 24a would be actuated directly. The valve control unit 16a is configured to mechanically actuate or mechanically pilot the refrigerant valves 14a, 24a. The valve control unit 16a comprises a first pilot valve 20a. The first pilot valve 20a is configured to pilot the first refrigerant valve 14a. The valve control unit 16a comprises a second pilot valve 30a. The second pilot valve 30a is configured to pilot the second refrigerant valve 24a. The pilot valves 20a, 30a are each realized as normally-closed valves.

The valve control unit 16a comprises a camshaft 18a. The camshaft 18a is specifically actuatable. The camshaft 18a is configured to actuate a plurality of pilot valves 20a, 30a of the valve control unit 16a, in particular at least the first pilot valve 20a and the second pilot valve 30a. The camshaft 18a could alternatively also be configured to directly actuate a plurality of refrigerant valves 14a, 24a of the refrigerant valve unit 12a, in particular at least the first refrigerant valve 14a and the second refrigerant valve 24a.

The valve control unit 16a comprises an electric motor unit 22a. The electric motor unit 22a comprises a stepping motor. The electric motor unit 22a is configured to drive the camshaft 18a precisely in an angle-controlled manner/to precisely set the angle of rotation of the camshaft 18a. The valve block 26a comprises a control module 76a. The control module 76a is in the form of a pilot module. All the pilot valves 20a, 30a of the valve block 26a are arranged in the control module 76a. The camshaft 18a is arranged in the control module 76a. The electric motor unit 22a is fastened to the control module 76a. The control module 76a and the refrigerant valve module 74a are connected together and form the valve block 26a as a result.

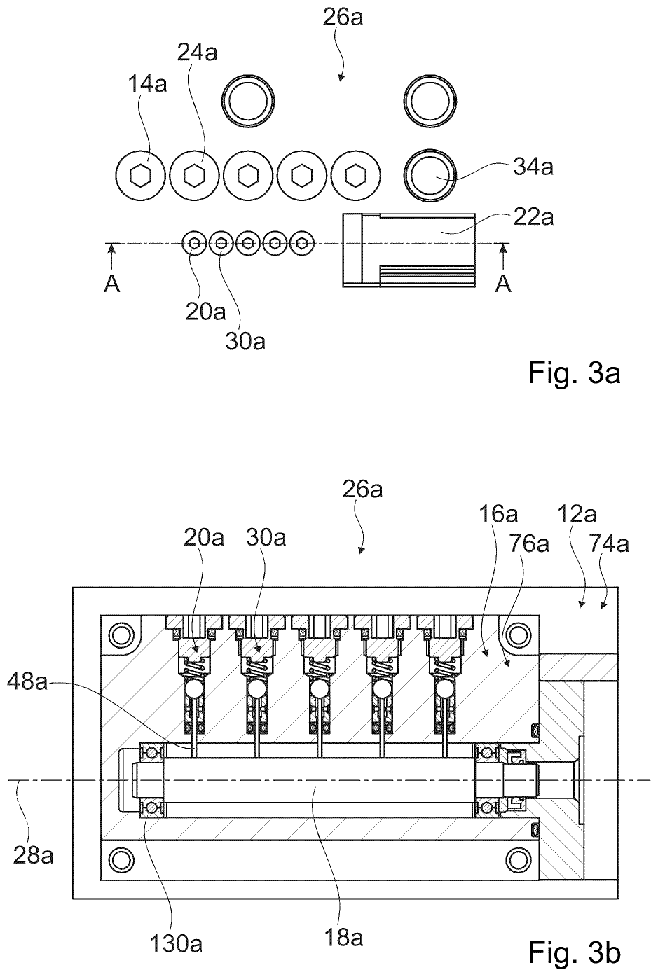

FIG. 3b schematically shows a section through the valve block 26a along a section axis A indicated in FIG. 3a. The camshaft 18a is illustrated in a simplified manner without cams 40a in FIG. 3b. The camshaft 18a is configured to actuate more than two pilot valves 20a, 30a. The illustrated camshaft 18a is configured, for example, to actuate five pilot valves 20a, 30a, wherein each of the pilot valves 20a, 30a pilots a separate refrigerant valve 14a, 24a in the form of a shut-off valve. The camshaft 18a is mounted so as to be rotatable about an axis of rotation 28a. The valve block 26a has, for example, grooved ball bearings 130a for rotatably supporting the camshaft 18a. Alternatively, a plain bearing would also be conceivable for rotatably supporting the camshaft 18a. The pilot valves 20a, 30a of the valve control unit 16a are arranged in a row parallel to the axis of rotation 28a of the camshaft 18a. The refrigerant valves 14a, 24a, in the form of shut-off valves, of the refrigerant valve unit 12a are likewise arranged in a row parallel to the axis of rotation 28a of the camshaft 18a (cf. also FIG. 2a or 3a).

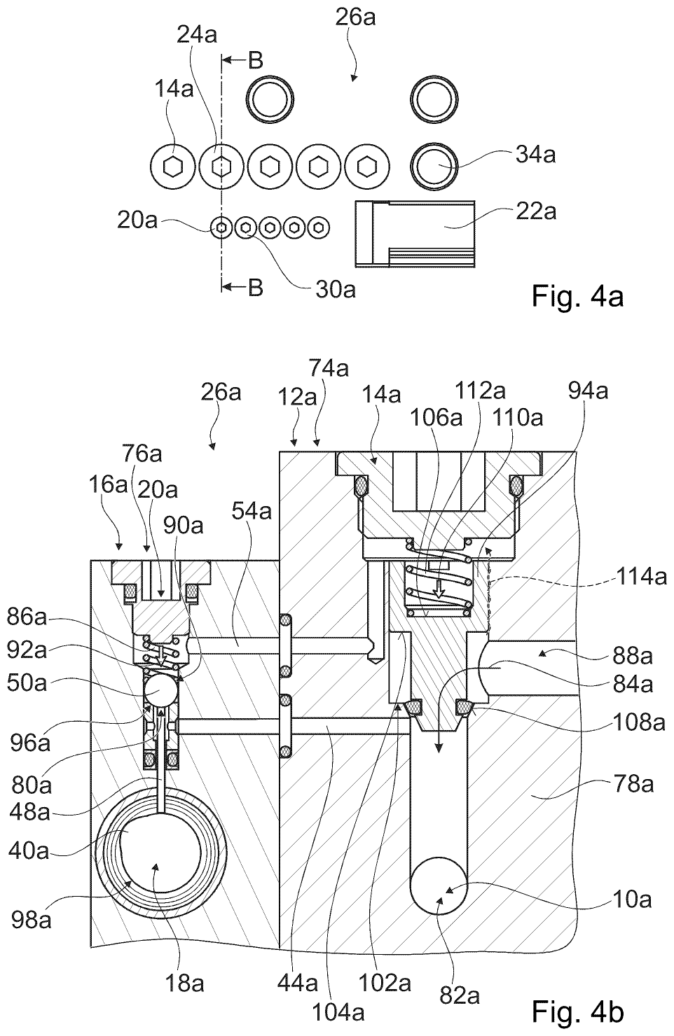

FIGS. 4b and 4c schematically show a section through the valve block 26a along a section axis B indicated in FIG. 4a. The first pilot valve 20a and the first refrigerant valve 14a are each illustrated in section in FIGS. 4b and 4c. The first pilot valve 20a has a valve element 50a. The valve element 50a is configured, when it is placed on a sealing seat 96a of the first pilot valve 20a, to fluidically separate a first pressure side 80a and a second pressure side 90a of the first pilot valve 20a (cf. FIG. 4b). However, if the valve element 50a has been lifted off the sealing seat 96a of the first pilot valve 20a, the two pressure sides 80a, 90a of the first pilot valve 20a are connected fluidically together (cf. FIG. 4c). The first pilot valve 20a has a restoring unit 86a. The restoring unit 86a of the first pilot valve 20a is formed by a spiral compression spring. The restoring element 86a of the first pilot valve 20a is configured to move/press the valve element 50a in onto the sealing seat 96a of the first pilot valve 20a. The first pilot valve 20a has a transmission element 48a. The transmission element 48a is in the form of a cylindrical pin. The transmission element 48a is configured to transmit a camshaft signal from the camshaft 18a mechanically to the valve element 50a of the first pilot valve 20a. The camshaft signal brings about a movement of the transmission element 48a in the direction of the valve element 50a. The transmission element 48a is in touching contact with the valve element 50a of the first pilot valve 20a and with the camshaft 18a. The transmission element 48a is realized in such a way that, in a first rotational position 98a (illustrated in FIG. 4b) of the camshaft 18a, it allows the sealing seat 96a of the first pilot valve 20a to be sealed off. In the first rotational position 98a of the camshaft 18a, a cam ring 36a associated with the first pilot valve 20a is set such that no cam 40a of the cam ring 36a is in contact with the transmission element 48a. The transmission element 48a is realized in such a way that, in a second rotational position 100a (illustrated in FIG. 4c) of the camshaft 18a, it prevents the sealing seat 96a of the first pilot valve 20a from being sealed off. In the second rotational position 100a of the camshaft 18a, the cam ring 36a associated with the first pilot valve 20a is set such that the cam 40a of the cam ring 36a is in contact with the transmission element 48a and as a result the valve element 50a is lifted out of the sealing seat 96a via the transmission element 48a.

The first refrigerant valve 14a has a slide element 94a. The slide element 94a has a sealing surface 108a. The slide element 94a is configured, when the sealing surface 108a sits on a sealing seat 102a of the first refrigerant valve 14a, to fluidically separate an entry 88a and an exit 82a of the first refrigerant valve 14a (cf. FIG. 4b). In the closed state, illustrated in FIG. 4b, of the first refrigerant valve 14a, the entry 88a is fluidically connected to a first pressure action surface 104a of the first refrigerant valve 14a. Via a leakage 114a of the slide element 94a, in the closed state, illustrated in FIG. 4b, of the first refrigerant valve 14a, a second pressure action surface 106a of the slide element 94a, which is arranged opposite to the first pressure action surface 104a of the slide element 94a, is also fluidically connected to the entry 88a, or, in this state, at least the same pressures 104a, 106a act on both pressure action surfaces 104a, 106a of the slide element 94a. Both pressure action surfaces 104a, 106a of the slide element 94a are located, as seen from the sealing surface 108a of the slide element 94a, on the same side of the sealing surface 108a. The first pressure action surface 104a has a smaller surface area than the second pressure action surface 106a. As a result, the slide element 94a is pressed onto the sealing seat 102a in the closed state illustrated in FIG. 4b. This is illustrated by the arrow 110a in FIG. 4b. In addition, the first refrigerant valve 14a has a restoring unit 112a, which is in the form of a spiral compression spring and likewise presses the slide element 94a in onto the sealing seat 102a.

In the closed state in FIG. 4b, the entry 88a of the first refrigerant valve 14a in the form of a shut-off valve is fluidically separated from an exit 82a of the first refrigerant valve 14a in the form of a shut-off valve. If the slide element 94a has been lifted off the sealing seat 102a of the first refrigerant valve 14a, the entry 88a and exit 82a of the first refrigerant valve 14a are connected fluidically together (cf. FIG. 4c). The first pilot valve 20a is fluidically connected to the first refrigerant valve 14a via a control channel 44a.

The control channel 44a is in the form of a recess/bore in a base body 78a of the valve block 26a. The control channel 44a connects the first pressure side 80a of the valve element 50a of the first pilot valve 20a to an exit 82a of the first refrigerant valve 14a in the form of a shut-off valve. The direction of flow of the refrigerant through the first refrigerant valve 14a in the open state is indicated by an arrow 84a. In the switched position in FIG. 4b, the first refrigerant valve 14a has been switched such that the exit 82a of the first refrigerant valve 14a is fluidically separated from an entry 88a of the first refrigerant valve 14a, with the result that the pressure at the exit 82a of the first refrigerant valve 14a, which is lower than the pressure applied to the entry 88a of the first refrigerant valve 14a, is applied to the first pressure side 80a of the valve element 50a of the first pilot valve 20a. The first pilot valve 20a is fluidically connected to the first refrigerant valve 14a via a further control channel 54a. The further control channel 54a is likewise in the form of a recess/bore in the base body 78a of the valve block 26a. The further control channel 54a connects the second pressure side 90a of the valve element 50a, opposite to the first pressure side 80a of the valve element 50a, of the first pilot valve 20a to the second pressure action surface 106a of the slide element 94a of the first refrigerant valve 14a. Since, as a result of the leakage 114a in the closed state in FIG. 4b, the same pressure is applied to the second pressure action surface 106a of the slide element 94a as to the entry 88a of the first refrigerant valve 14a, the same pressure is likewise applied to the second pressure side 90a of the valve element 50a of the first pilot valve 20a as to the entry 88a of the first refrigerant valve 14a. Consequently, in the closed state in FIG. 4b, the pressure on the second pressure side 90a of the valve element 50a (entry pressure) is greater than on the first pressure side 80a of the valve element 50a (exit pressure). This is indicated by the arrow 92a in FIG. 4b.

If the cam 40a of the cam ring 36a of the camshaft 18a now lifts the transmission element 48a such that the valve element 50a of the first pilot valve 20a is lifted off the sealing seat 96a, the pressure at the exit 82a of the first refrigerant valve 14a is applied via the two control channels 44a, 54a to the second pressure action surface 106a of the slide element 94a. As a result, the pressure on the second pressure action surface 106a of the slide element 94a is lower than the pressure on the first pressure action surface 104a of the slide element 94a (entry pressure) and the slide element 94a is lifted off the sealing seat 102a. The open state of the first refrigerant valve 14a in the form of a shut-off valve is thus set, as is illustrated in FIG. 4c. The open state is maintained for as long as the cam 40a keeps the valve element 50a of the first pilot valve 20a open.

Each of the pilot valves 20a, 30a of the valve control element 16a is fluidically connected to the respective associated refrigerant valve 14a, 24a via the control channels 44a, 54a. Each pilot valve 20a, 30a has a respective transmission element 48a, which is configured to transmit a camshaft signal associated with the pilot valve 20a, 30a mechanically to the respective valve element 50a of the respective pilot valve 20a, 30a.

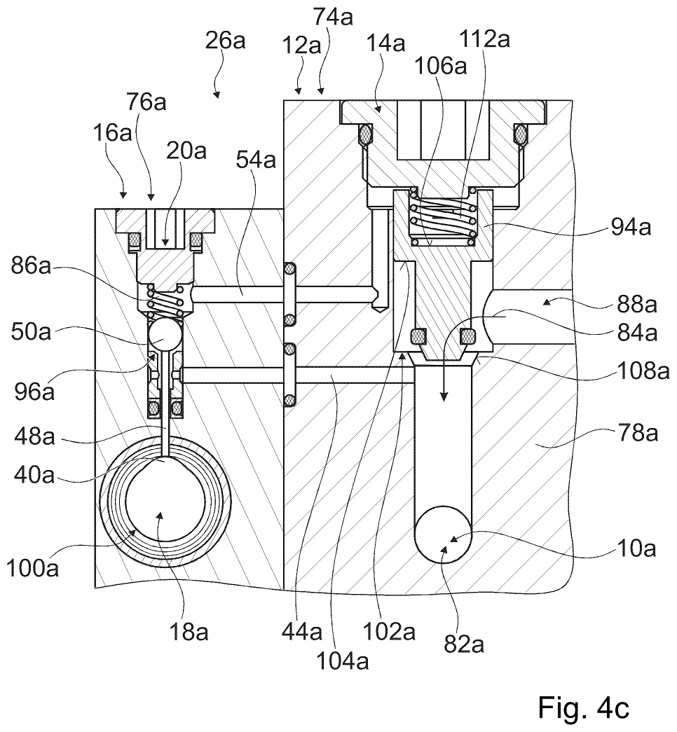

FIG. 5a shows a schematic illustration of the camshaft 18a with respectively associated transmission elements 48a of pilot valves 20a, 30a. Alternatively, the transmission elements 48a could also be associated directly with refrigerant valves 14a, 24a. The camshaft 18a has a plurality of cam rings 36a, 46a. In the example illustrated in FIG. 5, the camshaft 18a comprises five cam rings 36a, 46a. The cam rings 36a, 46a are each configured to actuate a transmission element 48a of one of the refrigerant valves 14a, 24a or of one of the pilot valves 20a, 30a. The cam rings 36a, 46a each can cams 40a, 40′a, 40″a. The cams 40a, 40′a, 40″a may be formed differently than one another. For example, one cam 40a may form a flat ramp 38a. The arrangement of the cam rings 36a, 46a on the camshaft 18a forms a plurality of specific switching patterns 42a, 42′a, 42″a, 42′″a, 42″″a for switching different operation states of the refrigerant circuit 10a (cf. FIG. 5b). Depending on the rotational position of the camshaft 18a, different combinations of transmission elements 48a are lifted/activated by the camshaft 18a. In the implementation, shown by way of example in FIG. 5b, with five switching patterns 42a, 42′a, 42″a, 42′″a, 42″″a a rotation of the camshaft 18a through in each case approximately 72° could bring about switching between the individual successive switching patterns 42a, 42′a, 42″a, 42′″a, 42″″a.

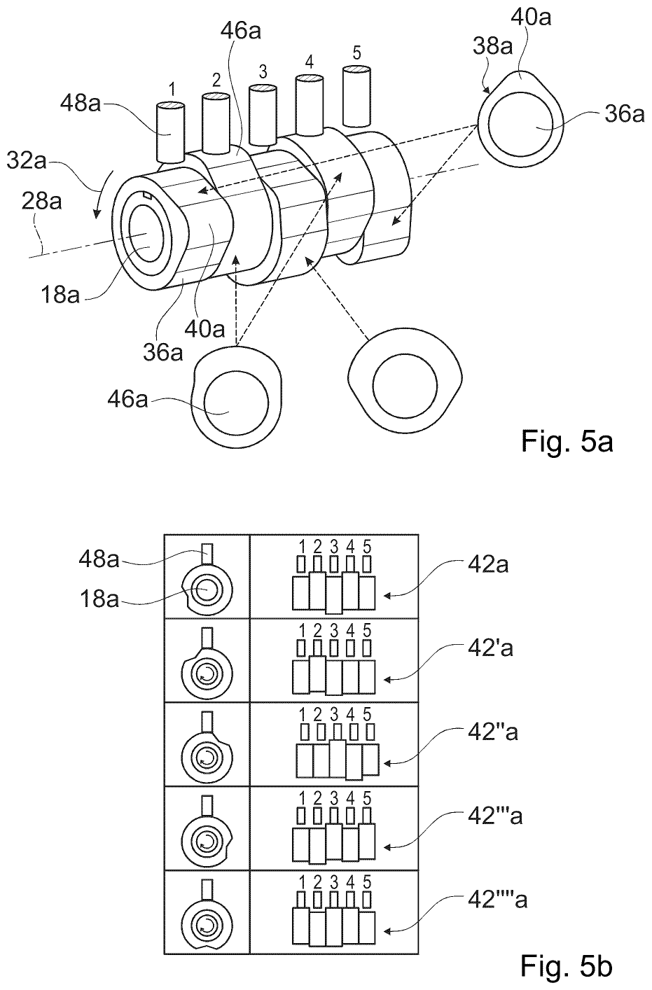

FIG. 6 shows a schematic flow chart of a method for operating the refrigerant circuit 10a. In at least one operating step 116a, a changed operating parameter is set at the air-conditioning system 68a or at the heat pump 58a with the aim of setting a desired operation state of the air-conditioning system 68a or of the heat pump 58a. In at least one further operating step 60a, the electric motor unit 22a is actuated such that the camshaft 18a takes up a rotational position 98a, 100a designated for the new operating parameter. As a result, one of a plurality of possible specific switching patterns 42a, 42′a, 42″a, 42′″a, 42″″a is set. In the further operation state 60a, the specifically actuatable camshaft 18a is used to actuate the plurality of pilot valves 20a, 30a, integrated in the common valve block 26a, to pilot the refrigerant valves 14a, 24a integrated in the common valve block 26a. Alternatively or additionally, the specifically actuatable camshaft 18a could, in the operating step 60a, also be used to actuate the plurality of refrigerant valves 14a, 24a integrated in the common valve block 26a. In at least one further operating step 118a, the air-conditioning system 68a or the heat pump 58a adopts the desired operation state.

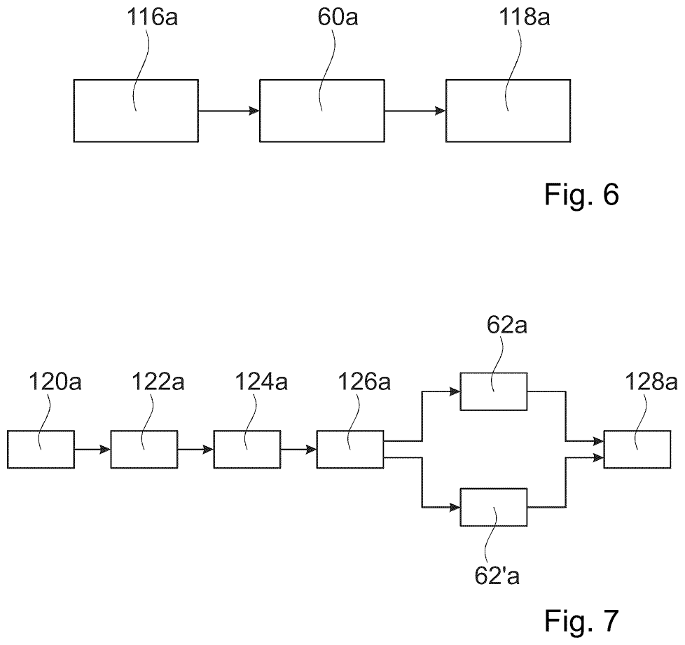

FIG. 7 shows a schematic flow chart of a method for producing the valve block 26a. In at least one production step 120a, a plurality of refrigerant valves 14a, 24a are integrated into a refrigerant valve module 74a. In at least one further production step 122a, a plurality of pilot valves 20a, 30a are integrated into a control module 76a. In at least one further production step 124a, the camshaft 18a is integrated into the control module 76a. In at least one further production step 126a, the electric motor unit 22a is mounted on the control module 76a. In at least one further production step 62a, the plurality of refrigerant valves 14a, 24a and the plurality of pilot valves 20a, 30a are integrated into the common valve block 26a by connecting the refrigerant valve module 74a to the control module 76a. Alternatively, in an alternative production step 62′a, the integration of the refrigerant valves 14a, 24a and of the pilot valves 20a, 30a could also be carried out directly into a single component. In at least one further production step 128a, the common valve block 26a is installed in a refrigerant circuit 10a, for example the air-conditioning system 68a or the heat pump 58a.

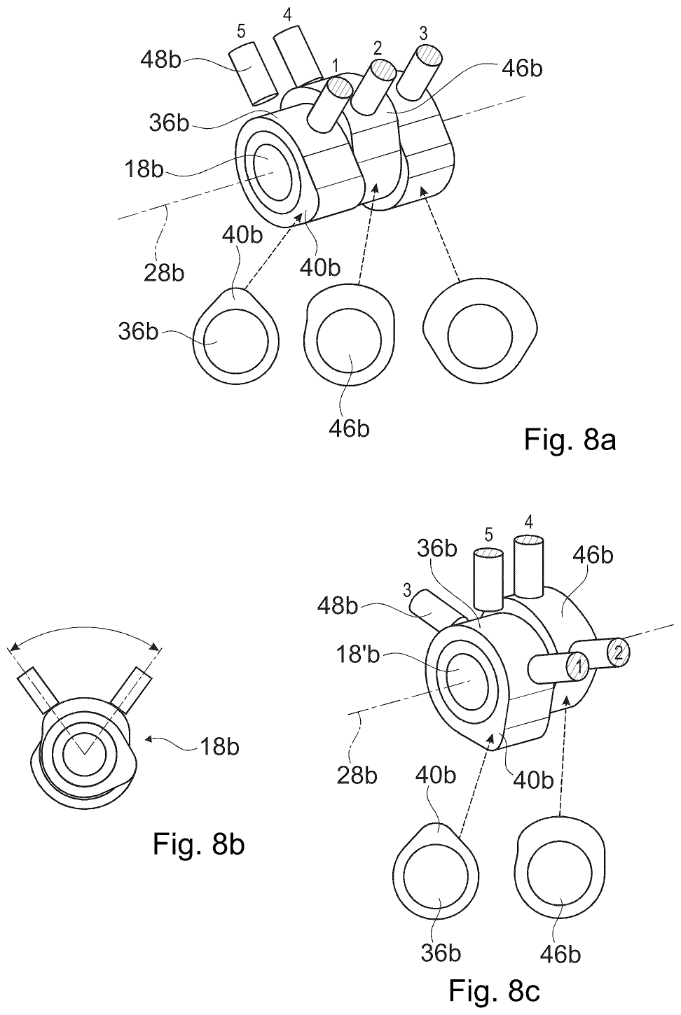

FIGS. 8a to 8c show a further exemplary embodiment of the invention. The following descriptions and the drawings are limited substantially to the differences between the exemplary embodiments, wherein, with regard to identically referenced components, in particular with regard to components with identical reference signs, reference can be made in principle to the drawings and/or the description of the other exemplary embodiments, in particular FIGS. 1 to 7. To differentiate the exemplary embodiments, the letter a has been placed after the reference signs of the exemplary embodiment in FIGS. 1 to 7. In the exemplary embodiments in FIGS. 8a to 8c, the letter a has been replaced by the letter b.

FIGS. 8a, 8b and 8c schematically show different views of alternative camshafts 18b, 18′b of an alternative valve control unit 16b of an alternative valve block 26b. The alternative valve control unit 16b has a plurality of pilot valves 20b, 30b. The alternative valve block 26b has a refrigerant valve unit 12b with a plurality of refrigerant valves 14b, 24b. The pilot valves 20b, 30b or alternatively the refrigerant valves 14b, 24b are arranged around an axis of rotation 28b of the alternative camshafts 18b, 18′b in the circumferential direction 32b of the alternative camshafts 18b, 18′b. The alternative camshafts 18b, 18′b in this case each have a number of cam rings 36b, 46b that is smaller than a number of pilot valves 20b, 30b that are actuated by the alternative camshafts 18b, 18′b. In the case of direct actuation of the refrigerant valves 14b, 24b by the alternative camshafts 18b, 18′b, the number of cam rings 36b, 46b of the alternative camshafts 18b, 18′b would then also be smaller than a number of refrigerant valves 14b, 24b that are actuated by the alternative camshafts 18b, 18′b.

The alternative camshaft 18b in FIGS. 8a and 8b has three cam rings 36b, 46b, which actuate five transmission elements 48b of pilot valves 20b, 30b or refrigerant valves 14b, 24b. The alternative camshaft 18′b in FIG. 8c has two cam rings 36b, 46b, which likewise actuate five transmission elements 48b of pilot valves 20b, 30b or refrigerant valves 14b, 24b. In both cases, the alternative camshaft 18b, 18′b has a cam ring 46b, which is configured to actuate transmission elements 48b of two different pilot valves 20b, 30b or of two different refrigerant valves 14b, 24b.

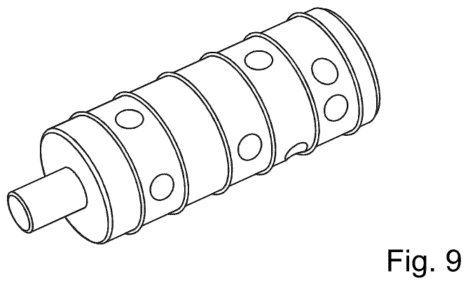

FIG. 9 shows an integration, not according to the invention, of the function of a plurality of shut-off valves into a single rotating body.

1. A valve block for a refrigerant circuit, comprising at least one refrigerant valve unit having at least one first refrigerant valve and at least one second refrigerant valve which are each configured at least to influence a refrigerant flow of the refrigerant circuit, and comprising a valve control unit which is configured at least to control and/or pilot at least some of the refrigerant valves of the refrigerant valve unit wherein the valve control unit has a specifically actuatable camshaft for actuating a plurality of refrigerant valves and/or a plurality of pilot valves of the valve control unit, in particular for actuating at least one first pilot valve of the valve control unit to pilot the first refrigerant valve and for actuating at least one second pilot valve of the valve control unit to pilot the second refrigerant valve.

2. The valve block as claimed in claim 1, wherein the valve control unit has at least one electric motor unit, in particular comprising at least one stepping motor, for driving the camshaft in an angle-controlled manner.

3. The valve block as claimed in claim 1, wherein the camshaft is designed to actuate more than two, preferably more than three and preferentially more than four refrigerant valves of the refrigerant valve unit or pilot valves, of the valve control unit.

4. The valve block as claimed in claim 1, wherein all of the refrigerant valves of a functional refrigerant circuit are integrated in the valve block.

5. The valve block as claimed in claim 1, wherein the pilot valves of the valve control unit or the refrigerant valves of the refrigerant valve unit are arranged in a row parallel to an axis of rotation of the camshaft and/or around the axis of rotation of the camshaft in the circumferential direction of the camshaft.

6. The valve block as claimed in claim 1, wherein the first refrigerant valve and/or the second refrigerant valve are/is realized as a shut-off valve for blocking the refrigerant flow at least in a subregion of the refrigerant circuit.

7. The valve block as claimed in claim 1, wherein the first refrigerant valve the second refrigerant valve and/or at least one separately actuated third refrigerant valve of the refrigerant valve unit are/is realized as an expansion valve of the refrigerant circuit.

8. The valve block as claimed in claim 7, wherein the camshaft has at least one cam ring comprising a cam that forms a flat ramp.

9. The valve block as claimed in claim 1, wherein the camshaft has a plurality of cam rings, which are each configured at least to actuate at least one refrigerant valve or at least one pilot valve, wherein the arrangement of the cam rings on the camshaft (18a-b) forms a plurality of specific switching patterns for switching different operation states of the refrigerant circuit.

10. The valve block as claimed in claim 1, wherein the camshaft has a number of cam rings that is less than a number of pilot valves of the valve control unit which are actuated by the camshaft, or than a number of refrigerant valves of the refrigerant valve unit which are actuated by the camshaft.

11. The valve block as claimed in claim 1, wherein the camshaft has a cam ring which is configured to actuate two or more different pilot valves or two or more different refrigerant valves.

12. The valve block as claimed in claim 1, wherein each pilot valve of the valve control unit is connected to the respective associated refrigerant valve at least via a control channel.

13. The valve block as claimed in claim 12, wherein each pilot valve of the valve control unit is connected to the same respective associated refrigerant valve at least via a further control channel.

14. The valve block as claimed in claim 1, wherein each pilot valve has at least one transmission element which is configured to transmit a camshaft signal mechanically to a valve element of the respective pilot valve.

15. The valve block as claimed in claim 1, wherein the pilot valves are realized as normally-closed valves.

16. The valve block as claimed in claim 1, wherein at least one integrated pressure/temperature sensor.

17. A refrigerant circuit in particular in a vehicle, preferably in a battery-electrically driven vehicle, and/or in a heat pump, preferably a building heat pump, having a valve block as claimed in claim 1.

18. A method for operating a refrigerant circuit as claimed in claim 17, wherein, in at least one operating step, a specifically actuatable camshaft is used to actuate a plurality of refrigerant valves which are integrated in a common valve block and/or to actuate a plurality of pilot valves which are integrated in the common valve block in order to pilot refrigerant valves which are integrated in the common valve block.

19. A method for producing a valve block as claimed in claim 1, wherein, in at least one production step, a plurality of refrigerant valves and preferably a plurality of pilot valves for piloting the refrigerant valves are integrated into a common valve block.
